(19) United States
(12) Patent Application Publication
(10) Pub. No.: US 2021/0383718 A1
(43) Pub. Date: Dec. 9, 2021

(54) PORTABLE GOAL-TRACKING DEVICE

(71) Applicant: Goal Grinders Tech LLC, Sacramento, CA (US)

(72) Inventor: Dakota Dilger, Sacramento, CA (US)

(73) Assignee: Goal Grinders Tech LLC, Sacramento, CA (US)

(21) Appl. No.: 16/894,462

(22) Filed: Jun. 5, 2020

(51) Int. Cl. G09B 19/00; G09B 5/04; G06F 3/16; G09F 27/00

(52) U.S. Cl. CPC G09B 19/003; G09B 5/04; G06Q 10/06316; G09F 27/00; G06F 3/165

(57) ABSTRACT

A portable device includes a body, a media player in the body, and a first button, a first display device, and a second button on the body. The first button, when pressed by a user, causes the media player to play a motivation message for motivating the user to take an action towards a goal. The first display device is configured to display a number indicating a total number of performed actions or remaining actions towards the goal. The second button is configured to, when pressed by the user, change the total number of performed actions or remaining actions towards the goal and the number displayed by the first display device.

### BACKGROUND

People often set short-term or long-term goals for themselves. However, to achieve the goals may require perseverance, self-discipline, and tremendous willpower. In particular, when a goal is set far out in the future or for a long time period, it can be narrowed into a miniscule point amid other commitments and responsibilities. Thus, for many people, a goal can be difficult to achieve without external assistance or motivation. For example, many people may desire to lose weight through regular exercises, but few people can follow through. In many cases, the goals may be more attainable if people can regularly see, hear, or otherwise be reminded of their goals and/or the current actions to take.

### SUMMARY

The present disclosure relates generally to techniques for helping people achieve a goal. More specifically, disclosed herein are techniques for helping people achieve their goals (e.g., long-term goals) by regularly reminding people of their goals and pending action items using, for example, a portable device. Various inventive embodiments are described herein, including devices, software applications, methods, systems, non-transitory computer-readable storage media storing programs, code, or instructions executable by one or more processors, and the like.

According to certain embodiments, a portable device may be used to help people achieve their long term goals by taking specific actions. The portable device may include a body, a media player in the body, and a first button, a first display device, and a second button on the body. The first button, when pressed by a user, may cause the media player to play a motivation message for motivating the user to take an action towards a goal. The first display device may be configured to display a number indicating a total number of performed actions or remaining actions towards the goal. The second button may be configured to, when pressed by the user, change the total number of performed actions or remaining actions towards the goal and the number displayed by the first display device. In some embodiments, the body may be in a shape of a wearable device, an accessory, or an ornament.

In some implementations of the portable device, the motivation message may include an audio clip selected from a library or a personalized audio message. The motivation message may be randomly selected from a plurality of audio clips stored in the portable device.

In some implementations, the portable device may further include a plurality of goal buttons arranged on the body according to a pattern, where each of the plurality of goal buttons, when pressed by the user, may cause a selection of at least one of a different respective goal or a different respective goal duration. In some implementations, the portable device may further include a plurality of display devices each corresponding to a respective goal button in the plurality of goal buttons and configured to display a respective number of performed actions or remaining actions. Each of the plurality of goal buttons, when pressed by the user, may further cause an increase or decrease of the respective number of performed actions or remaining actions.

In some implementations, the portable device may further include a plurality of action buttons arranged on the body according to a pattern, each of the plurality of action buttons corresponding to a type of actions in a plurality of types of actions towards the goal. In some implementations, the portable device may further include a plurality of display devices each corresponding to a respective action button in the plurality of action buttons and configured to display a respective number of performed actions or remaining actions in the corresponding type of actions towards the goal.

In some implementations, the portable device may further include a communication device configured to communicate with a computing device through a wired or wireless link. The wireless link may include a link based on a Wi-Fi, Bluetooth, NFC, or a cellular communication protocol. The portable device may be configurable by the computing device through the wired or wireless link. In some embodiments, the portable device may be configurable by the computing device through the wired or wireless link to set at least one of the goal, a duration of the goal, the motivation message, or a target number of actions towards the goal.

In certain embodiments, a method of motivating a user to achieve a goal may be performed by one or more computing systems. The method may include receiving, from a computing device executing a user application, instructions for configuring a portable device for motivating the user to achieve the goal; executing, by the portable device, the instructions to configure the portable device; displaying, by a first display device on the portable device, a number indicating a total number of performed actions or remaining actions towards the goal; playing, by a media player on the portable device and in response to the user pressing a first button on the portable device, a motivation message for motivating the user to take an action towards the goal; and changing, in response to the user pressing a second button on the portable device, the total number of performed actions or remaining actions towards the goal and the number displayed by the first display device.

In some embodiments of the method of motivating a user to achieve a goal, configuring the portable device may include setting at least one of the goal, a duration of the goal, the motivation message, one or more types of actions to take towards the goal, or a target number of actions towards the goal. In some embodiments, the method may further include receiving, using the user application executing on the computing device, user inputs regarding the goal. The user inputs may include at least one of the goal, a duration of the goal, the motivation message, one or more types of actions to take towards the goal, or a target number of actions towards the goal. In some embodiments, the motivation message may include an audio clip selected from a library or a personalized audio message recorded using the computing device and the user application. The motivation message may be randomly selected from a plurality of audio clips stored in the portable device.

In some embodiments, receiving the instructions for configuring the portable device comprises receiving the instructions from the computing device using a wired or wireless link. In some embodiments, the method of motivating a user to achieve a goal may also include, in response to the user pressing a goal button in a plurality of goal buttons arranged on the portable device, selecting a different respective goal from a plurality of goals, a different respective goal duration from a plurality of goal durations, or a different respective type of actions in a plurality of types of actions towards the goal. The method may further include displaying, by the first display device, the number indicating the total number of performed actions or remaining actions for the different respective goal, for the different respective goal duration, or for the different respective type of actions.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures:

FIG. 1 illustrates an example of a portable goal-tracking device according to certain embodiments;

FIG. 2 illustrates an example of setting goals and configuring a portable goal-tracking device using a mobile device according to certain embodiments;

FIG. 3 illustrates an example of a graphic user interface of a user application for setting goals and configuring a portable goal-tracking device according to certain embodiments;

FIG. 4 illustrates an example of a graphic user interface of a user application for setting goals and configuring a portable goal-tracking device according to certain embodiments;

FIG. 5 illustrates an example of a graphic user interface of a user application for setting goals and configuring a portable goal-tracking device according to certain embodiments;

FIG. 6 illustrates an example of a graphic user interface of a user application for setting goals and configuring a portable goal-tracking device according to certain embodiments;

FIG. 7 illustrates an example of a graphic user interface of a user application for setting goals and configuring a portable goal-tracking device according to certain embodiments;

FIG. 8 illustrates an example of a graphic user interface of a user application for setting goals and configuring a portable goal-tracking device according to certain embodiments;

FIG. 9 illustrates an example of a graphic user interface of a user application for setting goals and configuring a portable goal-tracking device according to certain embodiments;

FIG. 10 illustrates an example of a graphic user interface of a user application for setting goals and configuring a portable goal-tracking device according to certain embodiments;

FIG. 11 illustrates an example of a graphic user interface of a user application for setting goals and configuring a portable goal-tracking device according to certain embodiments;

FIG. 12 illustrates an example of a graphic user interface of a user application for setting goals and configuring a portable goal-tracking device according to certain embodiments;

FIG. 13 illustrates an example of a graphic user interface of a user application for setting goals and configuring a portable goal-tracking device according to certain embodiments;

FIG. 14 illustrates an example of a graphic user interface of a user application for setting goals and configuring a portable goal-tracking device according to certain embodiments;

FIG. 15 is a simplified flow chart illustrating an example of a method for tracking actions towards a goal using a portable goal-tracking device according to certain embodiments; and

FIG. 16 is a simplified block diagram of an example of a portable goal-tracking device according to certain embodiments.

### DETAILED DESCRIPTION

The present disclosure relates generally to techniques for helping people achieve a goal. More specifically, disclosed herein are techniques for helping people achieve their goals (e.g., long-term goals) by regularly reminding people of their goals and pending action items using, for example, a portable device that can be worn or carried by the user. In one embodiment, a portable device may include a body, a media player, a first button, a second button, and a display device on the body. The first button, when pressed by a user, may cause the media player to play a motivation message for motivating the user to take an action towards a goal. The first display device may be configured to display a number indicating a total number of performed actions or remaining actions towards the goal. The second button may be configured to, when pressed by the user, change the total number of performed actions or remaining actions towards the goal and the number displayed by the first display device.

Techniques disclosed herein can regularly and/or automatically remind people of their goals and pending action items, such that people can be continuously motivated to take actions towards the goal. The portable goal-tracking device can be worn or carried by the user and thus the user can regularly see, hear, or otherwise be reminded of their goals and/or the current actions to take. In addition, the user can personalize the motivation messages, such as a message from an idol, a family member, or a loved one, and thus is more likely to be motivated to stay on track.

In the following description, various inventive embodiments are described, including devices, software applications, methods, systems, non-transitory computer-readable storage media storing programs, code, or instructions executable by one or more processors, and the like. For the purposes of explanation, specific details are set forth in order to provide a thorough understanding of certain inventive embodiments. However, it will be apparent that various embodiments may be practiced without these specific details. The figures and description are not intended to be restrictive. The word “example” is used herein to mean “serving as an example, instance, or illustration.” Any embodiment or design described herein as “example” is not necessarily to be construed as preferred or advantageous over other embodiments or designs.

People may have goals to achieve in a short term or a long term. However, many people may not make detailed plans for achieving the goals, or may lack the strength of will or the perseveration in executing the plans, especially when the goal is a long-term goal or continuous effort is needed over a long period of time. According to certain embodiments, to motivate and keep a user on track of achieving a goal, a portable goal-tracking device may be used by the user to regularly see, hear, or otherwise be reminded of the goal and the action items set by the user towards the goal.

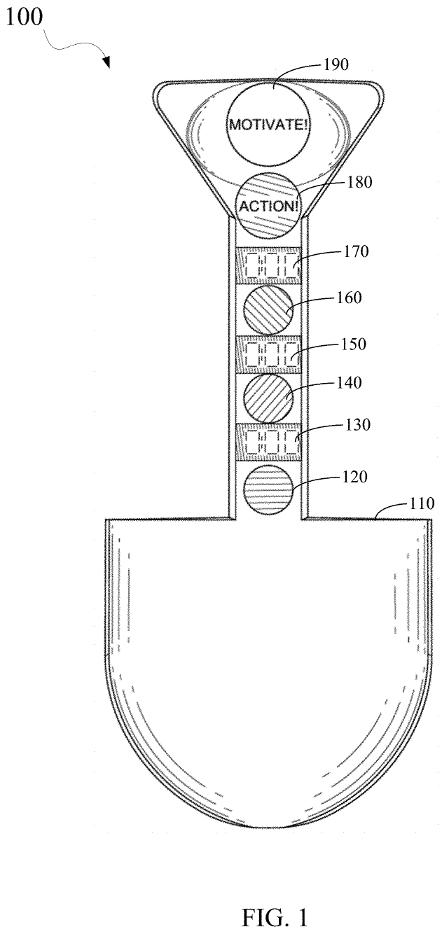

FIG. 1 illustrates an example of a portable goal-tracking device 100 according to certain embodiments. In the illustrated example, portable goal-tracking device 100 may be in a shape of a shovel. In other embodiments, the portable goal-tracking device may be in other shapes, such as an elongated object, a circular shape, a triangular shape, an oval shape, and the like. Portable goal-tracking device 100 may include a first portion 110 that may include a personal adornment, such as a jewelry, a badge, a cross, a cartoon character, a flower, an animal, or a small object of any shape. In some embodiments, portable goal-tracking device 100 may be in the form of a wearable accessory and may also include, for example, a chain, a band, a string, or a necklace (not shown in FIG. 1).

Portable goal-tracking device 100 may include multiple buttons (or keys) and display devices, such as LCD or LED displays. In the example shown in FIG. 1, portable goal-tracking device 100 may include a first button 120, a first display device 130, a second button 140, a second display device 150, a third button 160, a third display device 170, a fourth button 180, and a fifth button 190. First button 120, second button 140, and third button 160 may be in different colors or different shapes, or may be in the same color or shape. First button 120, second button 140, and third button 160 may be associated with different goals or goals of different durations. In one example, first button 120 may include a bronze circular button and may be associated with a 30-day goal; second button 140 may include a silver circular button and may be associated with a 90-day goal; and third button 160 may include a gold circular button and may be associated with a 180-day goal. In some embodiments, pushing a button 120, 140, or 160 may, for example, cause a corresponding goal to be selected, cause a corresponding goal to be replayed to the user, or change the number of remaining actions (or actions taken) for a corresponding goal. Each of first display device 130, second display device 150, and third display device 170 may be used to display the number of remaining actions (or actions that have been taken) for a corresponding goal.

In some embodiments, portable goal-tracking device 100 may include a single display device (e.g. first display device 130) and multiple buttons, such as first button 120, second button 140, and third button 160. Pressing first button 120, second button 140, or third button 160 may select one goal from multiple goals, or select one goal duration from multiple goal durations, and the corresponding number of remaining actions (or actions taken) may be displayed by first display device 130.

In some embodiments, multiple types of actions may need to be performed to achieve the goal, and each of buttons 120, 140, and 160 may correspond to a different respective type of actions in a plurality of types of actions towards the goal. Each of first display device 130, second display device 150, and third display device 170 may be used to display the respective number of performed actions or remaining actions for a respective type of actions in the plurality of types of actions towards the goal.

In some embodiments, one or more of buttons 120, 140, and 160 may not be used. For example, a portable goal-tracking device may not include buttons 140 and 160, and button 120 may be configured to select a first goal after being pressed once, to select a second goal after being pressed twice, to select a third goal after being pressed three time, and so on.

Fourth button 180 may be an action button, the pressing of which may indicate that an action has been taken. For example, to record an action taken for a first goal, first button 120 may be pressed, followed by the pressing of fourth button 180. In some embodiments, all actions may be the same and buttons 120, 140, and 160 may be associated with similar goals of different durations, pressing fourth button 180 may cause all display devices 130, 150, and 170 to change values. In some embodiments, portable goal-tracking device 100 may not include fourth button 180. For example, pressing button 120, 140, or 160 may cause display device 130, 150, or 170, respectively, to change the displayed value.

Fifth button 190 may be used to motivate the user to take actions. For example, pressing fifth button 190 may cause a pre-selected or pre-recorded motivation message to be played. The motivation message may include an audio clip or a video clip. In some embodiments, multiple motivation messages may be pre-selected or pre-recorded, and pressing fifth button 190 for different numbers of times may cause different motivation messages to be played. In some embodiments, additionally or alternatively, the motivation message may be automatically played at one or more preset time instants. For example, the motivation message may be automatically played in early morning, before lunch time, or after dinner on every day during the goal period (e.g., 90 days).

It is noted that the number of buttons and display devices, the sizes, shapes, colors, and functions of the buttons, and the arrangement of the buttons and display devices shown in FIG. 1 are for illustration purposes only. In different embodiments, the number of buttons and display devices, the sizes, shapes, colors, and functions of the buttons, or the arrangement of the buttons and display devices may be different. For example, the portable goal-tracking device may include more or fewer buttons, and may be arranged, vertically, horizontally, or according to a pattern, such as a circle.

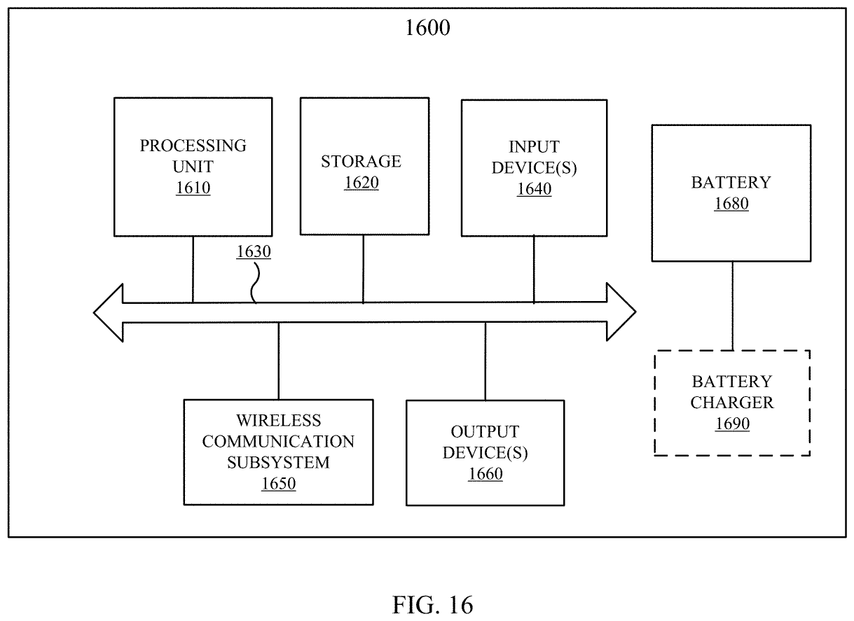

Portable goal-tracking device 100 may include various electronic components or subsystems, such as a processing unit, a memory device, a sensor, a media player (e.g., audio or video player), a display device (e.g., LCD or LED display), a wired or wireless communication subsystem, driver circuits, and the like. More details of the electronic components or subsystems of portable goal-tracking device 100 are described below with respect to, for example, FIG. 16.

In some embodiments, portable goal-tracking device 100 may be configured using at least some of the buttons on portable goal-tracking device 100. For example, pressing two buttons at the same time may set portable goal-tracking device 100 to a configuration mode, and then pressing button 120, 140, or 160 may set the target number of actions to take for the first goal, the second goal, or the third goal, respectively.

In some embodiments, portable goal-tracking device 100 may be configured using another electronic device, such as a smart phone, a tablet, a laptop, a desktop computer, or another computing device. Portable goal-tracking device 100 may be configured wirelessly or through a cable. For example, portable goal-tracking device 100 may communicate with a smart phone or a tablet through Wi-Fi, Bluetooth, NFC, or other wireless communication protocols, or may be connected to a tablet or a smart phone through a cable.

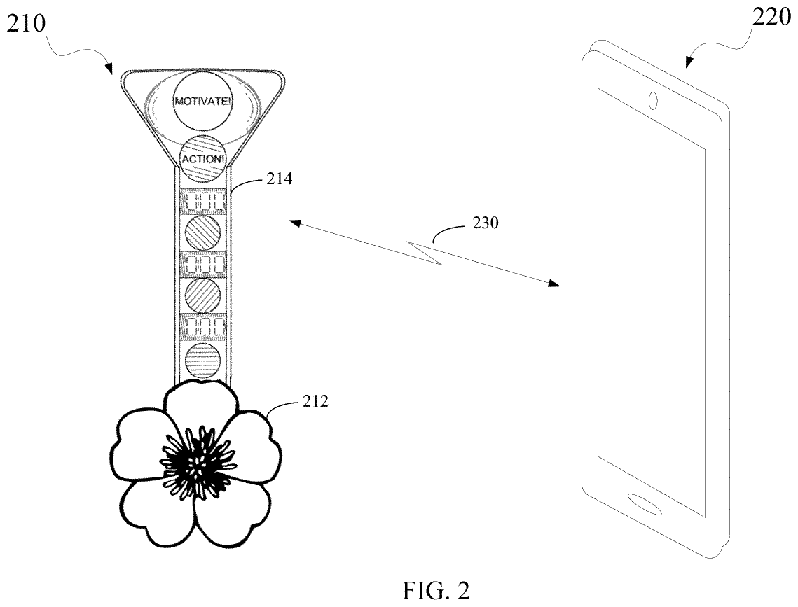

FIG. 2 illustrates an example of configuring a portable goal-tracking device 210 using a mobile device 220 according to certain embodiments. Portable goal-tracking device 210 may be an example of portable goal-tracking device 100, and may include a body 212 and a handle 214. In the example shown in FIG. 2, body 212 may be in the shape of a flower, and handle 214 may include multiple buttons and display devices as described above with respect to FIG. 1. Mobile device 220 may include, for example, a smart phone, a tablet, a laptop, or the like. Portable goal-tracking device 210 may communicate with mobile device 220 through a link 230, which may be a wired or wireless link. For example, link 230 may include a Bluetooth, IEEE 802.11 (Wi-Fi), WiMax, NFC, ZigBee, or cellular communication channel, or may include a cable with micro-USB, Lightning, or Thunderbolt connectors.

Mobile device 220 may configure portable goal-tracking device 210 through link 230 using a user application or other program code executed on mobile device 220. For example, as described in the example below, a user application may be used to set the goals, select or record motivation messages, and then transfer the goal setting and the motivation messages to portable goal-tracking device 210 to configure portable goal-tracking device 210.

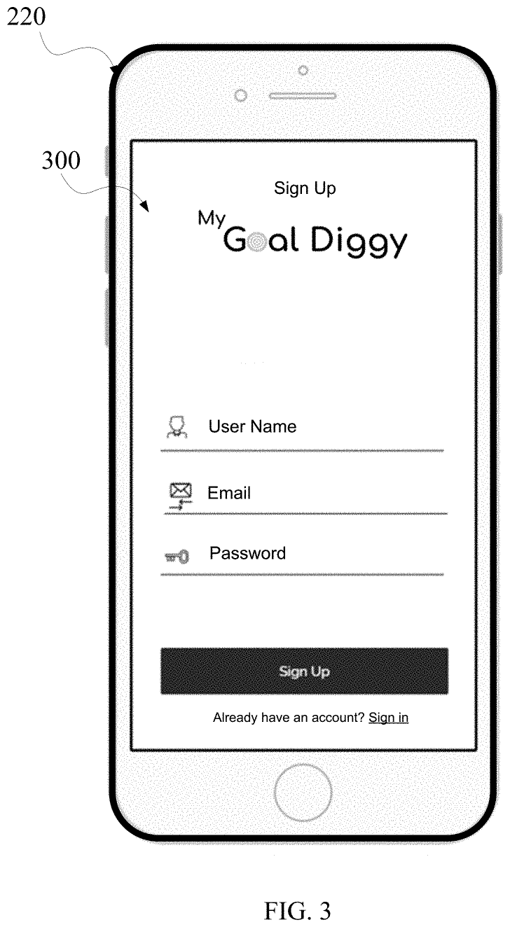

FIG. 3 illustrates an example of a graphic user interface (GUI) 300 of a user application for setting goals and configuring a portable goal-tracking device according to certain embodiments. The user application may be executed by, for example, mobile device 220. As illustrated in the example, GUI 300 may show a sign-up screen, where a user may set up an account with the user application by providing, for example, the user name, email, password, cellphone number, or other identification or verification information, in order to use the user application. In some embodiments, GUI 300 may not be used and the user may start the user application without a sign up or login procedure.

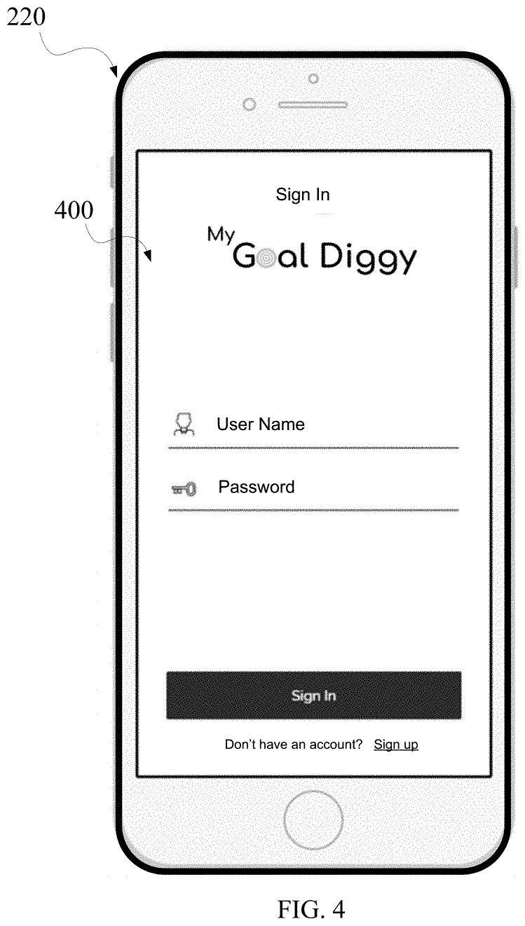

FIG. 4 illustrates an example of a graphic user interface 400 of a user application for setting goals and configuring a portable goal-tracking device according to certain embodiments. As illustrated, after a user has signed up with the user application, the user may sign in using GUI 400 by entering, for example, the user name, email, password, cellphone number, or other identification or verification information that is provided or set during the sign-up process.

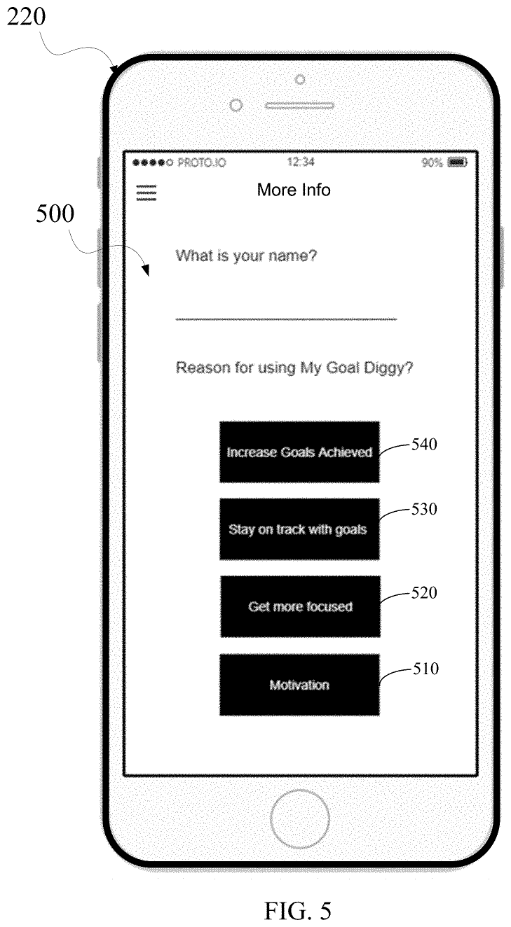

FIG. 5 illustrates an example of a graphic user interface 500 of a user application for setting goals and configuring a portable goal-tracking device according to certain embodiments. The user may use GUI 500 to enter the user's name and select one or more reasons for using the portable goal-tracking device. In the example shown by GUI 500, the user may select one or more reasons for using the portable goal-tracking device by clicking on buttons 510-540. For example, the user may click on button 510 to indicate that a reason for using the portable goal-tracking device is to be motivated, click on button 520 to indicate that a reason for using the portable goal-tracking device is to be more focused, click on button 530 to indicate that a reason for using the portable goal-tracking device is to stay on track with the goal, or click on button 540 to indicate that a reason for using the portable goal-tracking device is to increase the number of goals achieved. In some embodiments, the user may enter (e.g., by typing or recording) a different reason for using the portable goal-tracking device.

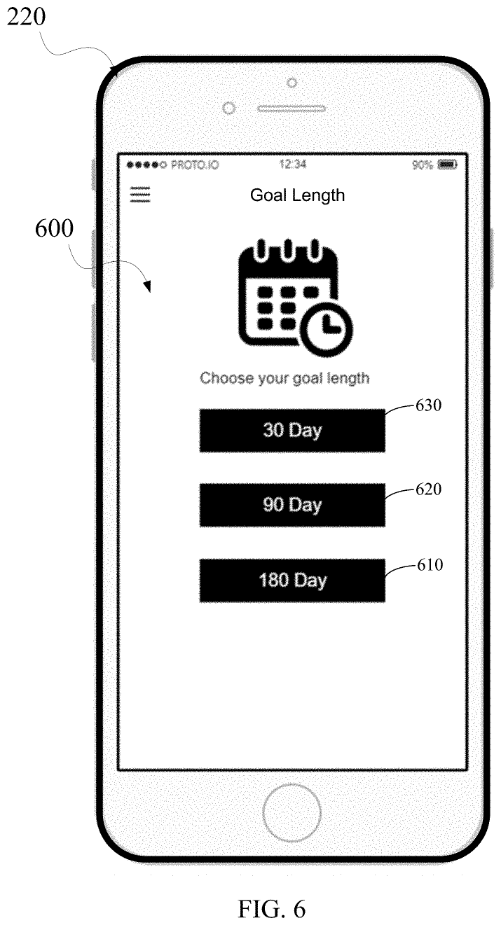

FIG. 6 illustrates an example of a graphic user interface 600 of a user application for setting goals and configuring a portable goal-tracking device according to certain embodiments. The user may use GUI 600 to select or set the target time period for achieving the goal. In the example shown by GUI 600, the user may set a 30-day goal by clicking or otherwise selecting a button 630, set a 90-day goal by clicking or otherwise selecting a button 620, or set a 180-day goal by clicking or otherwise selecting a button 610. In some embodiments, the user may enter (e.g., by typing or recording) a different target time period for achieving the goal.

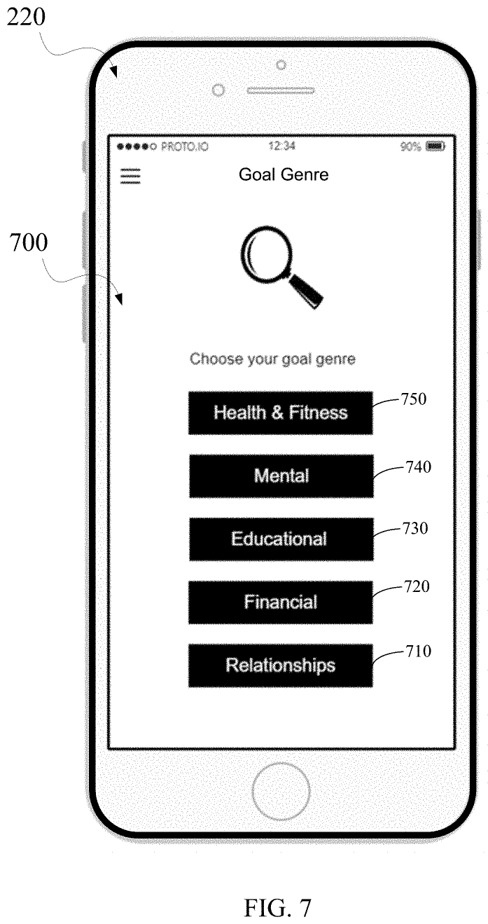

FIG. 7 illustrates an example of a graphic user interface 700 of a user application for setting goals and configuring a portable goal-tracking device according to certain embodiments. The user may use GUI 700 to select or set the type of goals to achieve. In the example shown by GUI 700, the user may set a goal related to relationships by clicking or otherwise selecting a button 710, set a financial goal by clicking or otherwise selecting a button 720, set an educational goal by clicking or otherwise selecting a button 730, set a goal related to mental fitness by clicking or otherwise selecting a button 740, set a goal related to health and fitness by clicking or otherwise selecting a button 750. In some embodiments, the user may enter (e.g., by typing or recording) a different type of goals if not listed.

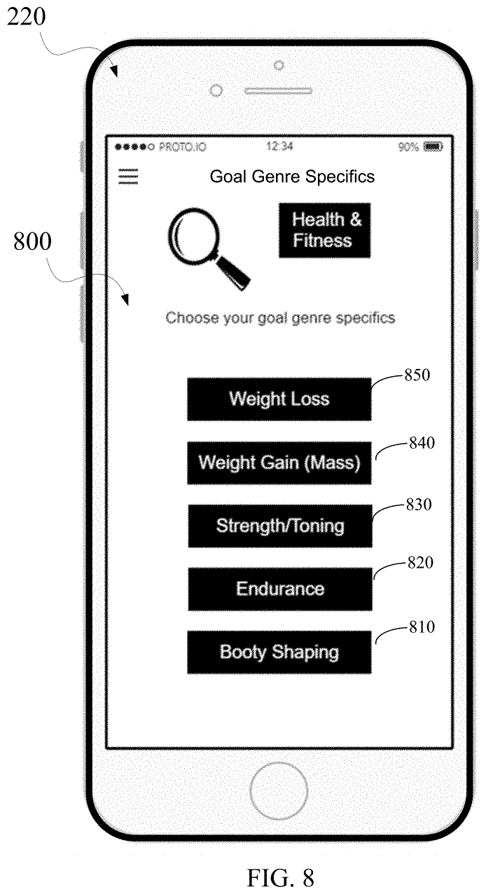

FIG. 8 illustrates an example of a graphic user interface 800 of a user application for setting goals and configuring a portable goal-tracking device according to certain embodiments. The user may use GUI 800 to select or set a goal related to health and fitness, for example, after the user selects button 750 in GUI 700. In the example shown by GUI 800, the user may set a goal for body shaping by selecting a button 810, set a goal for improving endurance by selecting a button 820, set a goal for improving strength and toning by selecting a button 830, set a goal for weight gain (or improving body mass index) by selecting a button 840, or set a goal for weight loss by selecting a button 850. In some embodiments, the user may enter (e.g., by typing or recording) a different goal related to health and fitness.

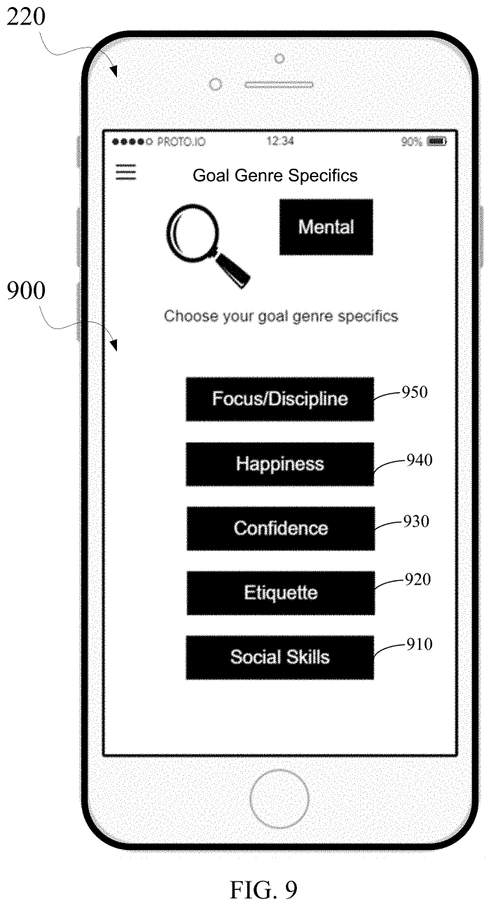

FIG. 9 illustrates an example of a graphic user interface 900 of a user application for setting goals and configuring a portable goal-tracking device according to certain embodiments. The user may use GUI 900 to select or set a goal related to mental fitness, for example, after the user selects button 740 in GUI 700. In the example shown by GUI 900, the user may set a goal for improving social skills by selecting a button 910, set a goal for improve etiquette by selecting a button 920, set a goal for improving confidence by selecting a button 930, set a goal for improving happiness by selecting a button 940, or set a goal for improving focus and discipline by selecting a button 950. In some embodiments, the user may enter (e.g., by typing or recording) a different goal related to mental fitness.

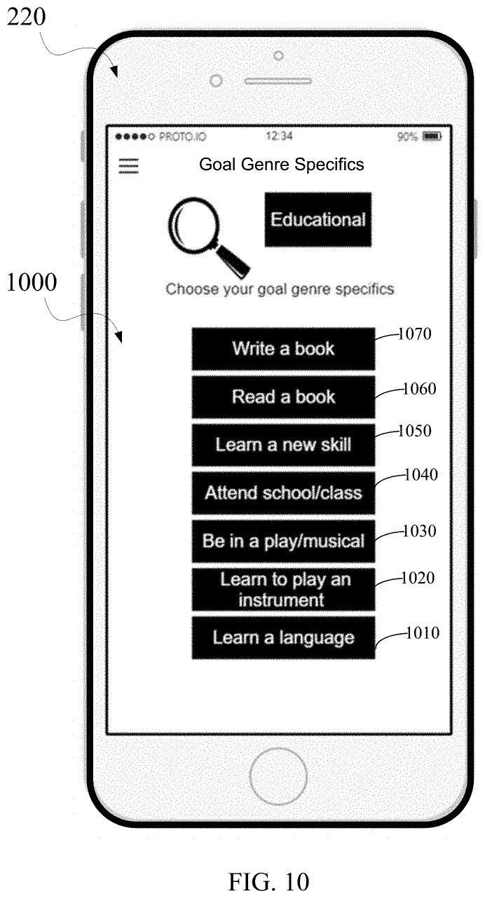

FIG. 10 illustrates an example of a graphic user interface 1000 of a user application for setting goals and configuring a portable goal-tracking device according to certain embodiments. The user may use GUI 1000 to select or set an educational goal, for example, after the user selects button 730 in GUI 700. In the example shown by GUI 1000, the user may set a goal to learn a language by selecting a button 1010, set a goal to learn a music instrument by selecting a button 1020, set a goal to participate in a play or a musical by selecting a button 1030, set a goal to attend a school or a course by selecting a button 1040, set a goal to learn a new skill by selecting a button 1050, set a goal to read a book by selecting a button 1060, or set a goal to write a book by selecting a button 1070. In some embodiments, the user may enter (e.g., by typing or recording) a different educational goal.

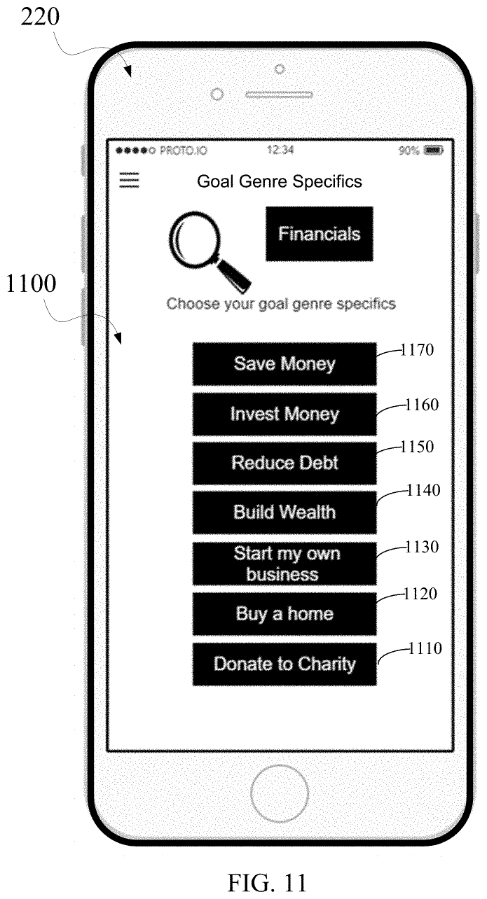

FIG. 11 illustrates an example of a graphic user interface 1100 of a user application for setting goals and configuring a portable goal-tracking device according to certain embodiments. The user may use GUI 1100 to select or set a financial goal, for example, after the user selects button 720 in GUI 700. In the example shown by GUI 1100, the user may, for example, set a goal to donate to a charity by selecting a button 1110, set a goal to buy a home by selecting a button 1120, set a goal to start a new business by selecting a button 1130, set a goal to build wealth by selecting a button 1140, set a goal to reduce debt by selecting a button 1150, set a goal to invest money by selecting a button 1160, or set a goal to save money by selecting a button 1170. In some embodiments, the user may enter (e.g., by typing or recording) a different financial goal.

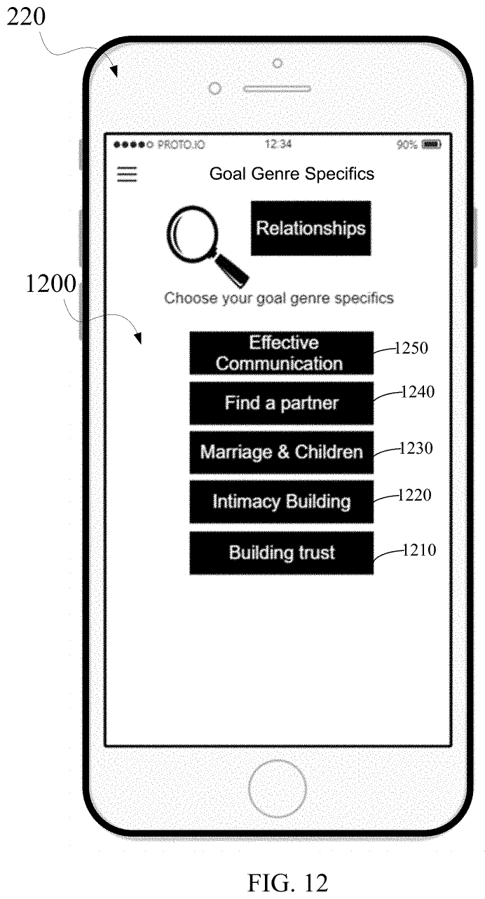

FIG. 12 illustrates an example of a graphic user interface 1200 of a user application for setting goals and configuring a portable goal-tracking device according to certain embodiments. The user may use GUI 1200 to select or set a goal related to personal relationships, for example, after the user selects button 710 in GUI 700. In the example shown by GUI 1200, the user may, for example, set a goal for building trust with another person by selecting a button 1210, set a goal for intimacy building by selecting a button 1220, set a goal for marriage and having children by selecting a button 1230, set a goal for finding a partner by selecting a button 1240, or set a goal for effective communication by selecting a button 1250. In some embodiments, the user may enter (e.g., by typing or recording) a different goal related to personal relationships.

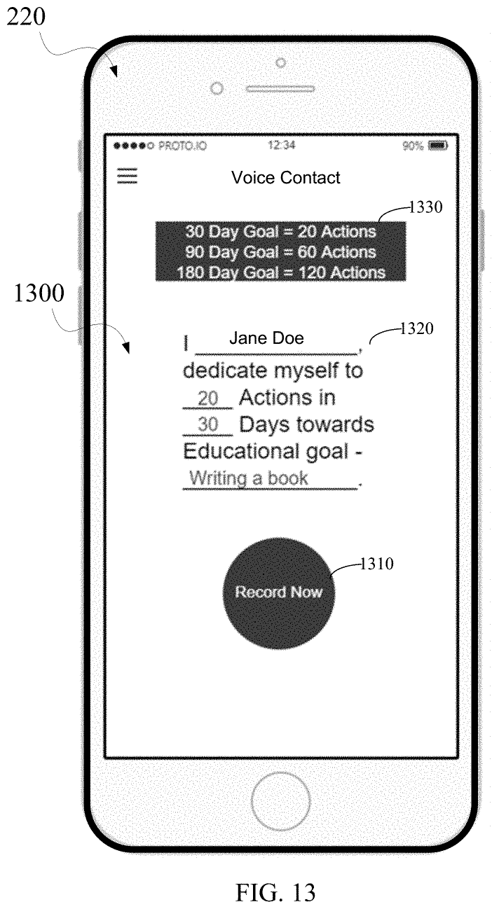

FIG. 13 illustrates an example of a graphic user interface 1300 of a user application for setting goals and configuring a portable goal-tracking device according to certain embodiments. The user may use GUI 1300 to record a specific goal. In some embodiments, based on the inputs by the user at other GUIs, the user application may provide a template for the specific goal. For example, as shown in FIG. 13, the user may have selected a 30-day educational goal for writing a book, where a 30-day educational goal may generally include, for example, 20 actions as indicated by an information box 1330. Thus, the user application may display a template 1320, which may include the user's name (e.g., “Jane Doe”), the time period for achieving the goal (e.g., 30 days), the number of actions (e.g., 20), and a short title of the goal (e.g., an educational goal to write a book). In some embodiments, the user's name, the time period, the number of action, and the short title of the goal may be edited. In some embodiments, the user may record the goal as a voice message by holding a button 1310 and verbally describing the goal.

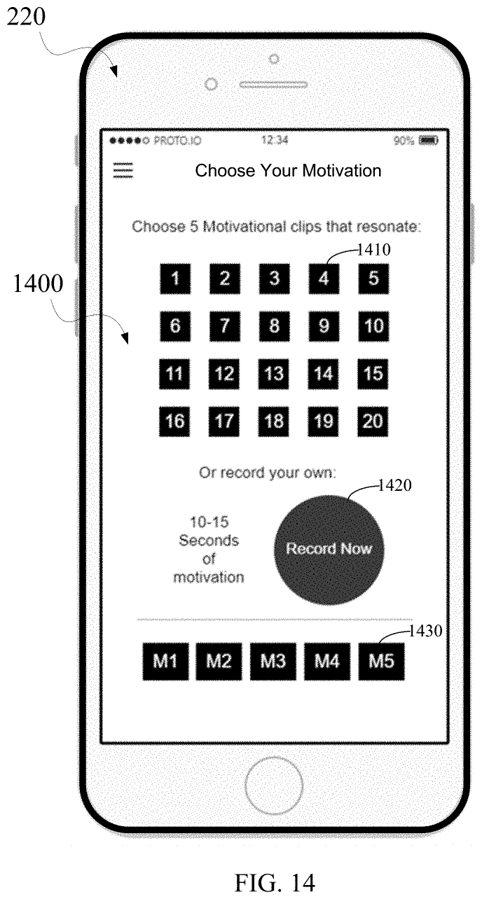

FIG. 14 illustrates an example of a graphic user interface 1400 of a user application for setting goals and configuring a portable goal-tracking device according to certain embodiments. The user may use GUI 1400 to select pre-recorded motivation messages or to record personalized motivation messages. In some embodiments, the motivation messages may include a clip of a song, a speech, a play, a message from a friend or family member, or the like. In some embodiments, the motivation messages may include an excerpt or a quote of a book or an article. The motivation messages may each have a duration about, for example, 10 to 15 seconds. In the example shown in FIG. 14, the user may select up to 5 motivation messages 1430 (M1, M2, M3, M4, and M5) from about 20 pre-recorded messages 1410 or may record personalized motivation message by holding a button while speaking.

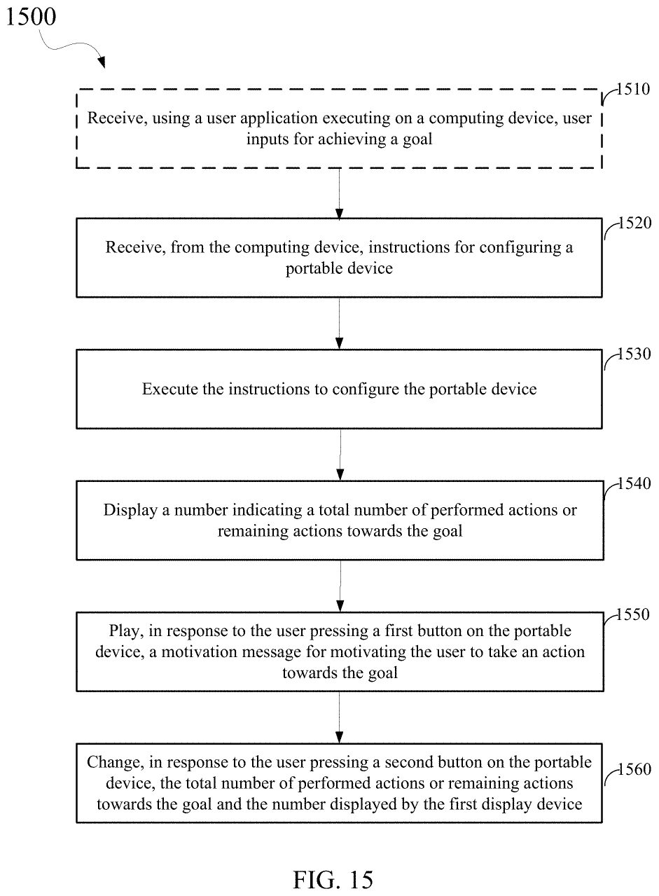

FIG. 15 is a simplified flow chart 1500 illustrating an example of a method of tracking actions towards a goal using a portable goal-tracking device according to certain embodiments. The method may be performed by any of the portable goal-tracking devices described above, or may be performed by a portable goal-tracking device in combination with a computing device, such as a mobile computing device or a computer. In some embodiments, the operations may be performed in an order different from that described in flow chart 1500, where various operations may be added, omitted, and/or combined.

Optionally, at block 1510, a computing device, such as a smart phone, a tablet, a laptop, a desktop, or the like, may receive, using a user application executing on the computing device, user inputs for achieving a goal. For example, the user may set the goals, the durations of the goals, the types and numbers of actions to take towards the goals, and the motivation messages using a user application as described above with respect to FIGS. 3-14. The user may select from preset goals, durations, types and numbers of actions, and motivation messages or may provide personalized or more specific goals, durations, types and numbers of actions, and motivation messages. For example, the user may set the motivation message by selecting an audio clip from a library or recording a personalized audio or video message using the microphone or camera of the computing device.

At block 1520, a portable goal-tracking device may receive, from the computing device, instructions for configuring the portable goal-tracking device. As described above, the portable goal-tracking device may communicate with the computing device through a wired or wireless link including, for example, a Bluetooth, IEEE 802.11 (Wi-Fi), WiMax, NFC, ZigBee, or cellular communication channel, or a cable with micro-USB, Lightning, or Thunderbolt connectors. The instructions may include the goals, durations, types and numbers of actions, and motivation messages selected or otherwise set by the user as described above with respect to block 1510.

At block 1530, the portable goal-tracking device may execute the instructions to configure the portable goal-tracking device. The configuration may include setting the goals, durations, types and numbers of actions, and motivation messages on the portable goal-tracking device. For example, the goals or the types of actions may be associated with the buttons, the numbers of actions may be save to a register, and the motivation message may be stored in a memory device.

At block 1540, the portable goal-tracking device may display a number indicating a total number of performed actions or remaining actions towards the goal. For example, the portable goal-tracking device may include one or more display devices, such as LED or LCD display, where each display device may display a number indicating the total number of performed actions or remaining actions towards a goal, the total number of performed actions or remaining actions for a goal duration, or the total number of performed actions or remaining actions in a type of actions towards the goal. The total number may be read from an incremental or decremental action counter that can count the total number of performed actions or remaining actions. For example, the action counter may increase or decrease the total number of action by one when the user indicates that an action towards the goal has been performed.

At block 1550, the portable goal-tracking device may, in response to the user pressing a first button on the portable device, play a motivation message for motivating the user to take an action towards the goal. The motivation message may be, for example, a text message, an audio clip, or a video clip. The portable goal-tracking device may include a media player, such as a text display device, an audio player, or a video player that can play the motivation message. In some embodiments, the user may select multiple motivation messages, which may be played randomly or according to a preset order when the user presses the first button. In some embodiments, additionally or alternatively, the portable goal-tracking device may automatically play the motivation message according to a preset schedule, such as every morning or every night.

At block 1560, the portable goal-tracking device may, in response to the user pressing a second button on the portable goal-tracking device, change the total number of performed actions or remaining actions towards the goal and thus the number displayed by the first display device. For example, after an action towards the goal has been performed, the user may press the second button once to indicate that an action has been taken, and the action counter in the portable goal-tracking device may then increase or decrease the total number of actions by one. The updated number in the action counter may then be read and displayed by the display device.

FIG. 16 is a simplified block diagram of an example of a portable goal-tracking device 1600, such as portable goal-tracking device 100 or 210 describe above, according to certain embodiments. The block diagram illustrates some electronic components or subsystems of the portable goal-tracking device. Portable goal-tracking device 1600 depicted in FIG. 16 is merely an example and is not intended to unduly limit the scope of inventive embodiments recited in the claims. One of ordinary skill in the art would recognize many possible variations, alternatives, and modifications. For example, in some implementations, portable goal-tracking device 1600 may have more or fewer subsystems than those shown in FIG. 16, may combine two or more subsystems, or may have a different configuration or arrangement of subsystems. Portable goal-tracking device 1600 may be in various shapes and may also include various mechanical or electro-mechanical components, such as buttons, as described above.

In the example shown in FIG. 16, portable goal-tracking device 1600 may include one or more processing units 1610 and a storage 1620. Processing units 1610 may be configured to execute instructions for performing operations at a number of components, and can be, for example, a micro-controller, a general-purpose processor, or a microprocessor suitable for implementation within a portable electronic device. Processing units 1610 may be communicatively coupled with a plurality of components within portable goal-tracking device 1600. To realize this communicative coupling, processing units 1610 may communicate with other components across a bus 1630. Bus 1630 may be any subsystem adapted to transfer data within portable goal-tracking device 1600. Bus 1630 may include a plurality of computer buses and additional circuitry to transfer data.

Storage 1620 may be coupled to processing units 1610. In some embodiments, storage 1620 may offer both short-term and long-term storage and may be divided into several units. Storage 1620 may be volatile, such as static random access memory (SRAM) and/or dynamic random access memory (DRAM), and/or non-volatile, such as read-only memory (ROM), flash memory, and the like. Furthermore, storage 1620 may include removable storage devices, such as secure digital (SD) cards. Storage 1620 may provide storage of computer readable instructions, data structures, program modules, audio recordings, image files, video recordings, and other data for portable goal-tracking device 1600. In some embodiments, storage 1620 may be distributed into different hardware modules. A set of instructions and/or code might be stored on storage 1620. The instructions might take the form of executable code that may be executable by portable goal-tracking device 1600, and/or might take the form of source and/or installable code, which, upon compilation and/or installation on portable goal-tracking device 1600 (e.g., using any of a variety of generally available compilers, installation programs, compression/decompression utilities, and the like), may take the form of executable code.

In some embodiments, storage 1620 may store a plurality of application modules, which may include any number of applications, such as applications for controlling an input device 1640 (e.g., a sensor, a switch, a camera, a microphone or audio recorder, etc.), or an output device 1660 (e.g., a speaker, a media player, a display device, etc.). Application modules may include particular instructions to be executed by processing units 1610. In some embodiments, certain applications or parts of application modules may be executable by other hardware modules, such as a wireless communication subsystem 1650. In certain embodiments, storage 1620 may additionally include secure memory, which may include additional security controls to prevent copying or other unauthorized access to secure information.

In some embodiments, storage 1620 may include an operating system loaded therein, such as an Android operating system or any other operating system suitable for mobile devices or portable devices. The operating system may be operable to initiate the execution of the instructions provided by the application modules and/or manage other hardware modules as well as interfaces with wireless communication subsystem 1650 which may include one or more wireless transceivers. The operating system may be adapted to perform other operations across the components of portable goal-tracking device 1600 including threading, resource management, data storage control, and other similar functionality.

Wireless communication subsystem 1650 may include, for example, an infrared communication device, a wireless communication device and/or chipset (such as a Bluetooth® device, an IEEE 802.11 (Wi-Fi) device, a WiMax device, cellular communication facilities, and the like), NFC, ZigBee, and/or similar communication interfaces. Portable goal-tracking device 1600 may include one or more antennas (not shown in FIG. 16) for wireless communication as part of wireless communication subsystem 1650 or as a separate component coupled to any portion of the system. Depending on desired functionality, wireless communication subsystem 1650 may include separate transceivers to communicate with base transceiver stations and other wireless devices and access points, which may include communicating with different data networks and/or network types, such as wireless wide-area networks (WWANs), WLANs, or wireless personal area networks (WPANs). A WWAN may be, for example, a WiMax (IEEE 802.9) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1650 may permit data to be exchanged with a network, other computing systems, and/or any other devices described herein. Wireless communication subsystem 1650 may include a means for transmitting or receiving data, such as identifiers of portable goal-tracking devices, position data, a geographic map, a heat map, photos, or videos, using antennas and wireless links. Wireless communication subsystem 1650, processing units 1610, and storage 1620 may together comprise at least a part of one or more of a means for performing some functions disclosed herein.

Portable goal-tracking device 1600 may include one or more input devices 1640, such as a sensor, a switch, a camera, a microphone or audio recorder, a communication port, or the like. For example, input devices 1640 may include one or more touch sensors or button sensors associated with the buttons. The touch sensors or button sensors may include, for example, a mechanical switch or a capacitive sensor that can sense the touching or pressing of a button. In some embodiments, input devices 1640 may include a microphone or audio recorder that may be used to record an audio message. The microphone and audio recorder may include, for example, a condenser or capacitive microphone using silicon diaphragms, a piezoelectric acoustic sensor, or an electret microphone. In some embodiments, the microphone and audio recorder may be a voice-activated device. In some embodiments, the microphone and audio recorder may record an audio clip in a digital format, such as MP3, WAV, WMA, DSS, etc. The recorded audio files may be saved to storage 1620 or may be sent to the one or more network servers through wireless communication subsystem 1650.

In some embodiments, input devices 1640 may include a camera, such as a high-definition pinhole camera or a camera with a miniature lens. The camera may include, for example, a charge-coupled device (CCD) or a complementary metal-oxide-semiconductor (CMOS) image sensor with a few millions or tens of millions of pixels. When implemented using a pinhole camera, the camera may have nearly infinite depth of field such that everything appears in focus without lens distortion, and thus no focusing may be needed. In some embodiments, input devices 1640 may include a location tracking device, such as a global positioning system (GPS) receiver, for determining a location of the portable goal-tracking device. For example, in some embodiments, the portable goal-tracking device may automatically play a motivation message or may play different motivation message, based on the location of the portable goal-tracking device. In some embodiments, input devices 1640 may include a wired communication port, such as a micro-USB, Lightning, or Thunderbolt transceiver.

Portable goal-tracking device 1600 may include one or more output devices 1660, such as a speaker, a media player, a display device, a communication port, or the like. For example, output devices 1660 may include a display device, such as an LED or LCD display and the corresponding driver circuit. Output devices 1660 may include a text, audio, or video player that may display a text message, play an audio clip, or display a video clip. In some embodiments, output devices 1660 may include a wired communication port, such as a micro-USB, Lightning, or Thunderbolt transceiver.

Portable goal-tracking device 1600 may include a rechargeable battery 1680 for providing electrical power to other circuits on portable goal-tracking device 1600. Rechargeable battery 1680 may include, for example, one or more alkaline batteries, lead-acid batteries, lithium-ion batteries, zinc-carbon batteries, and NiCd or NiMH batteries. Portable goal-tracking device 1600 may also include a battery charger 1690 for charging rechargeable battery 1680. In some embodiments, battery charger 1690 may include a wireless charging antenna that may support, for example, one of Qi, Power Matters Association (PMA), or Association for Wireless Power (A4WP) standard, and may operate at different frequencies. In some embodiments, battery charger 1690 may include a hard-wired connector, such as, for example, a micro-USB or Lightning® connector, for charging rechargeable battery 1680 using a hard-wired connection.

In some embodiments, portable goal-tracking device 1600 may include a plurality of other hardware modules. Each of the other hardware modules may be a physical module within portable goal-tracking device 1600. Examples of other hardware modules may include, for example, an accelerometer, a pressure module, a proximity sensor, a capacitive touch sensor, a near field communication (NFC) module, an ambient light sensor, or any other similar module operable to provide sensory output and/or receive sensory input.

Portable goal-tracking device 1600 may be implemented in many different ways. In some embodiments, the different components of portable goal-tracking device 1600 described above may be integrated to a same printed circuit board. In some embodiments, the different components of portable goal-tracking device 1600 described above may be placed in different physical locations and interconnected by, for example, electrical wires. Portable goal-tracking device 1600 may be implemented in various physical forms and may have various external appearances. The components of portable goal-tracking device 1600 may be positioned based on the specific physical form.

The portable goal-tracking device may be in the form of a commonly worn item. For example, the portable goal-tracking device may take the form of a personal adornment (e.g., jewelry, bracelets, necklaces, or badges) or other commonly worn items. The components of the portable goal-tracking device may be housed in an internal cavity.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, and the like), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer-program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, and the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A portable device comprising:
a body;
a media player in the body;
a first button on the body, the first button, when pressed by a user, causing the media player to play a motivation message for motivating the user to take an action towards a goal;
a first display device on the body and configured to display a number, the number indicating a total number of performed actions or remaining actions towards the goal; and
a second button on the body, wherein the second button is configured to, when pressed by the user, change the total number of performed actions or remaining actions towards the goal and the number displayed by the first display device.

2. The portable device of claim 1, wherein the body is in a shape of a wearable device, an accessory, or an ornament.

3. The portable device of claim 1, wherein the motivation message includes an audio clip selected from a library or a personalized audio message.

4. The portable device of claim 1, wherein the motivation message is randomly selected from a plurality of audio clips stored in the portable device.

5. The portable device of claim 1, further comprising a plurality of goal buttons arranged on the body according to a pattern, each of the plurality of goal buttons, when pressed by the user, causing a selection of at least one of a different respective goal or a different respective goal duration.

6. The portable device of claim 5, further comprising a plurality of display devices each corresponding to a respective goal button in the plurality of goal buttons and configured to display a respective number of performed actions or remaining actions.

7. The portable device of claim 6, wherein each of the plurality of goal buttons, when pressed by the user, further causes an increase or decrease of the respective number of performed actions or remaining actions.

8. The portable device of claim 1, further comprising a plurality of action buttons arranged on the body according to a pattern, each of the plurality of action buttons corresponding to a type of actions in a plurality of types of actions towards the goal.

9. The portable device of claim 8, further comprising a plurality of display devices each corresponding to a respective action button in the plurality of action buttons and configured to display a respective number of performed actions or remaining actions in the corresponding type of actions towards the goal.

10. The portable device of claim 1, further comprising a communication device configured to communicate with a computing device through a wired or wireless link.

11. The portable device of claim 10, wherein the wireless link includes a link based on a Wi-Fi, Bluetooth, NFC, or a cellular communication protocol.

12. The portable device of claim 10, wherein the portable device is configurable by the computing device through the wired or wireless link.

13. The portable device of claim 12, wherein the portable device is configurable by the computing device through the wired or wireless link to set at least one of:
the goal;
a duration of the goal;
the motivation message; or
a target number of actions towards the goal.

14. A method of motivating a user to achieve a goal, the method comprising:
receiving, from a computing device executing a user application, instructions for configuring a portable device for motivating the user to achieve the goal;
executing, by the portable device, the instructions to configure the portable device;
displaying, by a first display device on the portable device, a number indicating a total number of performed actions or remaining actions towards the goal;
playing, by a media player on the portable device and in response to the user pressing a first button on the portable device, a motivation message for motivating the user to take an action towards the goal; and
changing, in response to the user pressing a second button on the portable device, the total number of performed actions or remaining actions towards the goal and the number displayed by the first display device.

15. The method of claim 14, wherein configuring the portable device comprises setting at least one of:
the goal;
a duration of the goal;
the motivation message;
one or more types of actions to take towards the goal; or
a target number of actions towards the goal.

16. The method of claim 14, further comprising receiving, using the user application executing on the computing device, user inputs regarding the goal, the user inputs including at least one of:
the goal;
a duration of the goal;
the motivation message;
one or more types of actions to take towards the goal; or
a target number of actions towards the goal.

17. The method of claim 14, wherein the motivation message includes an audio clip selected from a library or a personalized audio message recorded using the computing device and the user application.

18. The method of claim 14, wherein receiving the instructions for configuring the portable device comprises receiving the instructions from the computing device using a wired or wireless link.

19. The method of claim 14, wherein the motivation message is randomly selected from a plurality of audio clips stored in the portable device.

20. The method of claim 14, further comprising:
selecting, in response to the user pressing a goal button in a plurality of goal buttons arranged on the portable device,
a different respective goal from a plurality of goals;
a different respective goal duration from a plurality of goal durations; or
a different respective type of actions in a plurality of types of actions towards the goal; and
displaying, by the first display device, the number indicating the total number of performed actions or remaining actions for the different respective goal, for the different respective goal duration, or for the different respective type of actions.
